(19) United States
(12) Patent Application Publication
(10) Pub. No.: US 2010/0144449 A1
(43) Pub. Date: Jun. 10, 2010

(54) GAMING TOKEN

(75) Inventors: Boris Poel, Heidelberg West (AU); William Westmore Purton, Melbourne (AU)

Correspondence Address: CONNOLLY BOVE LODGE & HUTZ LLP, 1875 EYE STREET, N.W., SUITE 1100, WASHINGTON, DC, 20006, US

(73) Assignee: ELIXIR GAMING TECHNOLOGIES INC., Las Vegas, NV (US)

(21) Appl. No.: 12/516,385

(22) PCT Filed: Nov. 12, 2007
(86) PCT No.: PCT/AU07/01736

§ 371 Date: Dec. 2, 2009

(30) Foreign Application Priority Data
Nov. 13, 2006 (AU) 2006906311

(51) Int. Cl. A63F 9/24; C04B 41/00

(52) U.S. Cl. 463/47; 264/132; 428/195.1

(57) ABSTRACT

A method of forming a gaming plaque in which a decorative design is printed onto a clear polymer film which is then thermoformed into an outer plaque face; two plaque faces are then injection moulded together with a suitable polymer between the rear faces of the faces to form a gaming plaque. An electronic identification and data device connected to an antenna is located between said plaque films or adhered to the rear of one of said plaque films.

This invention relates to an improved gaming token of the kind used in casinos or. In particular it is directed to a method of making it.

### BACKGROUND TO THE INVENTION

Plaques are high value gaming tokens used in casinos and are required to be larger and appear to be more expensive than lower value gaming chips.

Conventionally plaques are hand made. A printed clear film is laminated with layers of reflective mesh and polyester and shaped to form a shell with a decorative surface that is created by the layers behind the clear printed film. Two shells are then brought together with the decorative faces outermost. The space between the shells is filled with a plastic binder to create a plaque. The decorative effect is elaborate to make counterfeiting of the plaques difficult. This is an expensive and time consuming process.

U.S. Pat. No. 5,794,532 discloses a method of decorating a gaming chip using pressure pad marking of the surface and edge.

WO 2004/009366 discloses transparent ink for use in a pressure pad method of decorating a gaming chip.

Gaming chips with transponders capable of carrying data that can be read and updated from a remote controller are known from Australian patents 699025 and 700269 disclose gaming chip constructions in which an electronic device is embedded in a cell or recess around which the gaming token is moulded. The concept is to have a gaming chip that is identifiable and can be tracked as it moves around the casino. The transponder is adapted to be read and written to so that the identification data can be updated. U.S. Pat. No. 6,659,875 discloses a simpler construction where the transponder and antenna are located beneath the gaming token label.

It is an object of this invention to provide a less expensive method of producing gaming plaques of high quality appearance.

### BRIEF DESCRIPTION OF THE INVENTION

To this end the present invention provides a method of forming a gaming plaque in which a decorative design is printed onto a clear polymer film which is then thermoformed into an outer plaque face; two plaque faces are then injection moulded together with a suitable polymer between the rear faces of the faces to form a gaming plaque.

This invention is predicated on the discovery that the decorative effects favoured for gaming plaques may be achieved by sophisticated printing processes such as silk screen printing and lithography using appropriate decorative inks. Elaborate detailed designs that are difficult to counterfeit can be produced using known screen printing and lithographic printing techniques. This allows the process of forming the plaques to be simplified. Most plaques have an outer surface with a raised rib about the periphery and the decoratively printed film is preferably vacuum or thermoformed into the appropriate surface contours. Two of the formed faces are then inserted into an injection moulding die and an appropriate polymer injected to fill the space between the faces and form a plaque. The edge of the plaque may be coloured by the polymer between the plaque faces. In some instances stripes are incorporated in the edges to provide a visible code for identifying the value or origin of the plaques. These stripes can be added to recesses in the edge s formed during injection moulding.

In a preferred embodiment the plaque may incorporate an RFID electronic device suitable to retain unique identification data and a history of transactions. It may be of the type disclosed in U.S. Pat. No. 5,651,548 which is readable at locations within a casino and capable of sending and receiving data. Usually an antenna will also be needed and this is attached to the electronic chip. The electronic chip and antenna is preferably incorporated between the two plaque faces during fabrication.

In another aspect this invention provides a gaming plaque which includes
a) a body portion having two faces
b) a decoratively printed shaped plaque film on each face
c) an electronic identification and data device connected to an antenna located between said plaque films or adhered to the rear of one of said plaque films

Electronic chips operable in the 12-15 MHz range are preferred as they require smaller antenna and less power to operate. They can also be made to be robust enough for the moulding operations necessary to form the gaming chip.

The method of forming plaques according to this invention is faster because the visual effects are created in the printing of the plaque film and is less expensive because the labour content in making the plaques is reduced.

### DETAILED DESCRIPTION OF PREFERRED EMBODIMENTS

A preferred embodiment of the invention is illustrated in the drawings in which:

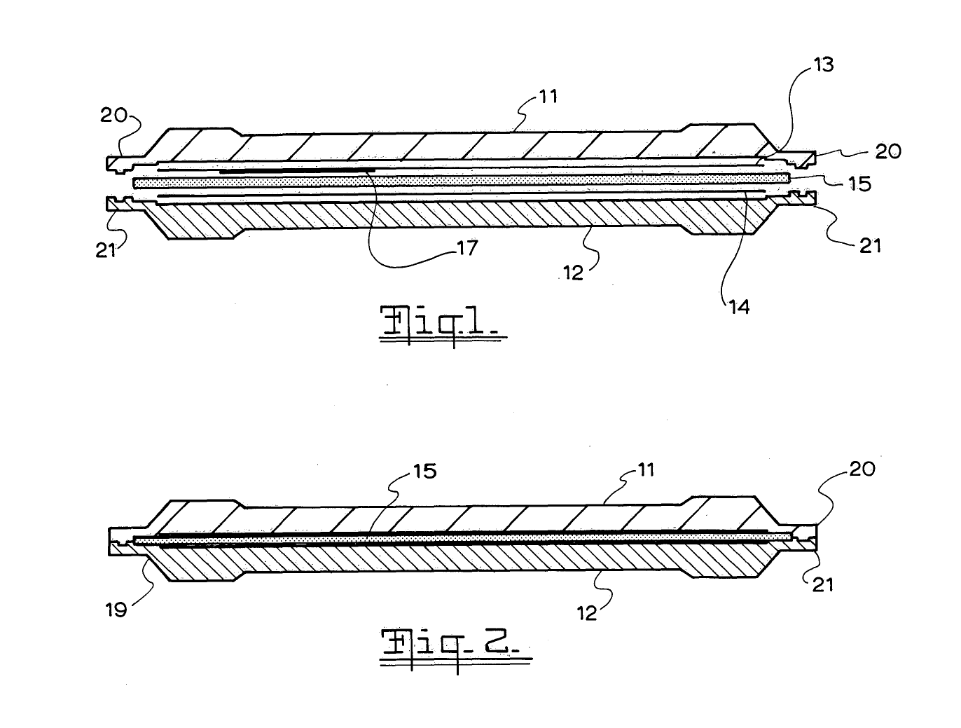

FIG. 1 is a side exploded view of the components of the plaque;

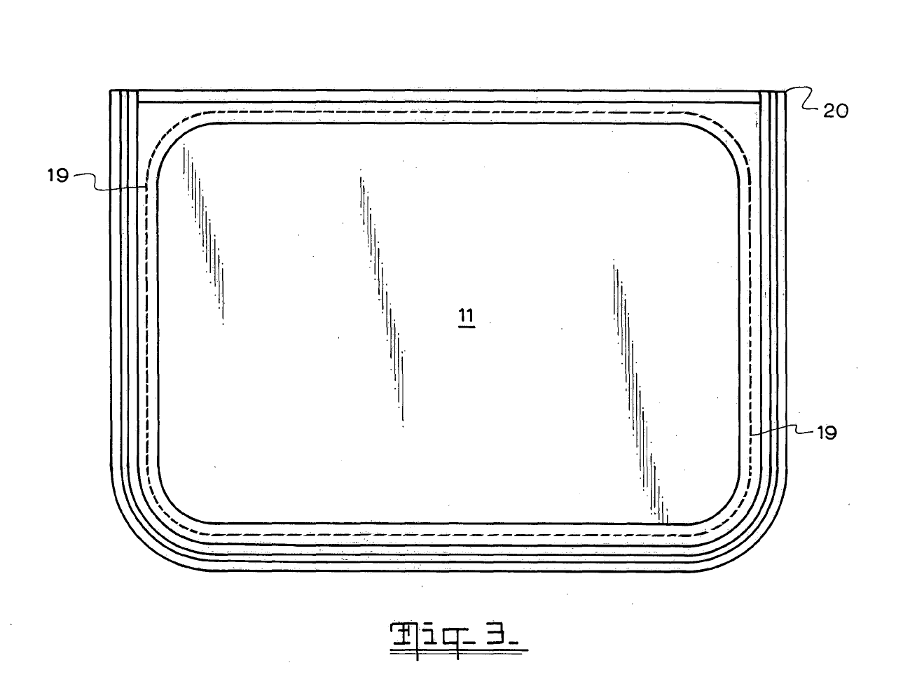

FIG. 2 is a side view of the formed plaque;

FIG. 3 is a plan view of the plaque of FIG. 2.

The plaque as shown in the drawings is composed of two mating shells 11, 12 composed of transparent resin material. On the rear of each shell 11, 12 is a decorative film 13, 14. The two shells with their attached decorative films are joined together by the adhesive filler layer 15 of polyurethane or similar resin.

An RFID chip or other electronic identification tag 17 is adhered to the surface of one of the decorative films 13, 14.

The plaque shells are shaped in a mould to form the male shell 11 with the location rib in the edge flange 20 and shell 12 having the complementary groove in the edge flange 21. These are formed from any suitable transparent resin such as acrylic, polystyrene or polycarbonate which may be treated for UV stability strength, toughness and scratch resistance.

The decorative films 13, 14 are preferably coated with a holographic coating to mimic a background such as mother of pearl and then printed with the desired image. The decorated face of the film 13, 14, is then attached to the internal surface of the shell 11, 12. The attachment is preferably made using a transparent adhesive such as polyurethane or methacrylate. An electronic identification device preferably addressable by a radio frequency is attached to the back of one of the films 13, 14.

The shells 11, 12, are brought together so that the edge flanges mate. The space between the backs of the films 13, 14 is then filled with a coloured filler resin 15 chosen for its adhesive and strength properties. The filling occurs through the slot in the edge of the joined shells that does not have the edge flanges 20, 21 as shown in FIG. 3.

After the resin 15 is cured the edge flanges 20, 21 are removed by cutting along the line 19 using any suitable cutting technique although a laser is preferred. This produces a coloured edge effect that is desirable for plaques.

Other enhancements to the plaques are within the scope of this invention including the incorporation of glass beads in the transparent resin used to form the shells 11, 12 to provide colour effects when the angle of incident light is changed. For security patterns may be encrypted in to the hologram pattern to make counterfeiting difficult. Similarly nano trace technology can be used to incorporate minor amounts of nano trace elements in the resins used in the shells 11, 12 or the filler 15 so that the authenticity of the plaques can be checked using optical spectrographic techniques.

From the above it can be seen that the present invention provides a simple and inexpensive alternative to gaming plaques as currently used. Those skilled in the art will realize that this invention may be implemented in embodiments other than those disclosed without departing the core teachings of this invention.

1. A method of forming a gaming plaque in which a decorative design is printed onto a clear polymer film which is then thermoformed into an outer plaque face; two plaque faces are then injection moulded together with a suitable polymer between the rear faces of the faces to form a gaming plaque.

2. A method as claimed in claim 1 in which each plaque face incorporates an edge flange adapted to mate with the edge flange of a corresponding plaque face and after the space between the plaque faces is filled the edge flanges are removed.

3. A method as claimed in claim 1 in which an electronic identification device is adhered to the internal face of one of said plaque faces.

4. A gaming plaque which includes
a) a body portion having two faces
b) a decoratively printed plaque film on each face
c) an electronic identification and data device connected to an antenna located between said plaque films or adhered to the rear of one of said plaque films.

5. A gaming plaque as claimed in claim 2 in which the electronic identification device is adapted to transmit and receive data in the frequency range 12-15 MHz.
